(19) United States
(12) Patent Application Publication
(10) Pub. No.: US 2010/0316982 A1
(43) Pub. Date: Dec. 16, 2010

(54) TIME-OUT DEVICE

(76) Inventor: Gursaran Singh, Oxford (GB)

Correspondence Address: DAVIS & BUJOLD, P.L.L.C., 112 PLEASANT STREET, CONCORD, NH, 03301, US

(21) Appl. No.: 12/812,794

(22) PCT Filed: Jan. 9, 2009
(86) PCT No.: PCT/GB09/00050

§ 371 Date: Jul. 14, 2010

(30) Foreign Application Priority Data
Jan. 16, 2008 (GB) 0800795.7

(51) Int. Cl. G09B 19/00

(52) U.S. Cl. 434/236

(57) ABSTRACT

A child time-out device (1) comprises: (I) a timer unit providing a visual display (2) providing an indication (3, 4, 12) of time either remaining or served during a time-out period; and (ii) an audio unit comprising (a) one or more memory units for storing a plurality of pre-recordable voice messages for reinforcing behavioural reflection by the child during the time-out period and time reminders, and (b) one or more playing units (8) for audibly relaying the messages to the child. The device helps misbehaving children to reflect upon their undesirable behavior, during a time-out period initiated by their parent(s)/guardian(s), with the objective of modifying such behaviour. Use of the device encourages this by providing pre-recorded guidance messages, which are accompanied by auditory reminders and visually displayed information of minutes remaining, or served, in time-out.

This application is a national stage completion of PCT/GB2009/000050 filed on Jan. 9, 2009 which claims priority from British Application Serial No. 0800795.7 filed Jan. 16, 2008.

### TECHNICAL FIELD

The present invention relates to a time-out device for aiding behavior modification by reflection in child discipline. In particular, it relates to such a device that periodically emits pre-recorded voice messages to help misbehaving children reflect during a ‘time-out’ period scenario upon their preceding undesirable behavior as well as providing feedback on time either remaining or served during that period. The device and the method embodied in it help familiarize such children with the concept of time and numbers in general and thus has an ancillary educational role.

### BACKGROUND ART

The time-out disciplinary method has been widely accepted for children usually between the ages of 2 and 11. It involves removing parental/guardian attention from the child after undesirable activity or behavior by the child, by placing them in a different environment such as a ‘naughty step’ or ‘naughty chair’ for a given time period so that the child can return to normalized behavior thereafter, having calmed down and reflected upon what they have done wrong. Generally, the overall length of ‘time-out’ is related to the child's age. Thus, time-out for a 4 year old would be 4 minutes and 5 minutes for a 5 year old and so forth. Time can be added-on or re-set for any misbehavior or deviations by the child during the time-out session.

A fundamental problem inherent with this concept is that it is extremely difficult to direct a young child to engage in the relatively complex cognitive process of reflecting upon their own behavior especially given that the parent/guardian is to avoid any interaction with the child in time-out, so as not to inappropriately and inadvertently reward and therefore negatively reinforce such behaviors. Further, children usually have a short attention span and thus can potentially readily forget why they were given time-out in the first instance.

Moreover, young children typically have no real concept of time, which increases the danger that they can become preoccupied with thinking and asking, prematurely and repeatedly, when their time-out will finish and thus leading to undue anxiety and frustration. In turn, if the parent/guardian reacts to these situations by interacting with the child, for instance by verbally informing them how long they have remaining in time-out, this serves to provide counter-productive attention to the child and thereby contravenes a fundamental principle of time out, namely that it is actually time away from the comfort of parental/guardian attention. The same is true if the parent/guardian interacts with the child to inform them of any additional time added-on minutes or time re-set if the child deviates from the time-out session.

WO-A-2007/135365 discloses a time-out pad or seat on which a naughty child is placed. By sensing weight and therefore the presence of a child on the pad, it sets off an alarm system if the child moves off the pad in order to alert the parent during time-out. Also, the duration of time in time-out is abstractly represented via a traffic light signaling system. However, this device does not pro-actively direct or guide the child to reflect upon their behavior and nor does it provide any visual or auditory feedback of linear concrete time remaining in terms of actual minutes or seconds. Furthermore, for any deviations during time-out by the child, re-setting has to be carried out manually on the pad itself through parental/guardian involvement which potentially provides further attention to the child, which can be rewarding and therefore reinforcing. In essence, the pad can be seen as more of a punitive containment device for detaining the child in a time-out scenario as opposed to a means of addressing the main purpose of the exercise, namely to aid behavior modification through reflection without further reinforcing attention.

US-A-2005/249048 discloses a more general child's time-keeping device, as opposed to a specific time-out aid, that provides a visual indication of how much time has elapsed by controlling a corresponding movement of an object (for example a toy vehicle) along a display from a beginning point to an end point. The reaching of the end point may optionally be accompanied by a sound. As such the proposed device displays the passing of time in an abstract form only and can be used for generalised time-monitored activities.

WO-A-9601444 discloses a child's disciplinary device that includes a plush toy (for example a cuddly bear) and a countdown timer secured to the toy. Although setting the secured timer sets the time-out period, the correspondence between ages and time-out periods is non-linear. Further, the device has the confounding effect of rewarding misdemeanours by giving the child a toy to play with. Moreover, it serves to potentially distract the child from reflection rather than encouraging it. No pro-active audio feedback is given to the child during the time-out period, no audio time remaining information is provided, and the device has no re-set function if the child deviates from a time-out session that avoids any further involvement/interaction by the time-out enforcer.

It is one aim of the present invention to provide a time-out device for use in time-out situations that overcomes the disadvantages of the prior art and helps children to reflect more fully during a time-out session upon their preceding undesirable behavior by progressing the presently limited time-out method from a mere behaviorism technique to a more integrated approach through the use of pro-active cognitive components.

It is a second aim of the present invention to provide such a time-out device that also provides visual and auditory feedback on concrete linear time-out minutes remaining, or time served, with the extraneous positive educational by-product of helping children to become conversant with the passing of time and to familiarize them with numbers.

### DISCLOSURE OF INVENTION

Thus, according to one aspect, the present invention provides a time-out device for aiding behavioral reflection by a misbehaving child, in which the device comprises a timer unit for providing a visual indication of passage of time in a time-out period, the indication being of remaining time of the time-out period to be served or of already-served time of the time-out period, an audio unit which comprises memory means for storing a plurality of pre-recorded voice messages, and playing means operable to audibly relay the pre-recorded voice messages to the child, and operating means to operate the playing means in dependence upon the passage of time in the time-out period, the operating means operating the playing means synchronized to the passage of time in the time-out period to relay the pre-recorded voice messages to the child in time-related succession through the time-out period.

In another aspect of the invention a method for aiding behavioural reflection by a misbehaving child during a period of time-out, comprises operating a timer unit to provide a visual indication to the child of passage of time in a time-out period, the indication being of remaining time to be served of the period of time-out, or of already-served time of the period of time-out, storing a plurality of pre-recorded voice messages, and audibly relaying the stored pre-recoded voice messages to the child synchronised to the passage of time in the time-out period, the audibly relaying of the pre-recorded voice messages to the child being in time-related succession through the time-out period.

The present invention seeks to help children to reflect upon their behavior during time-out by giving pre-recorded messages, accompanied by auditory reminders and visual information of minutes remaining, or served, which are set off at the start and, preferably, as each minute passes of their stated time-out period. These messages actively remind the child, in a calm voice using child friendly language, of the need to think about their behavior. A final message, towards or at the end of the time-out period, may suggest that they apologize to and hug the person who put them in time-out once the period has finished (for the general purpose of encouraging children to bear no grudges and move on), whilst reminding them not to repeat the undesirable behavior.

The present invention will now be described, in a non-limiting way, by the following preferred examples with reference to, and as illustrated in, the accompanying figures, in which:

### BRIEF DESCRIPTION OF DRAWINGS

FIG. 1A illustrates a front perspective view of a time-out device according to one embodiment of the present invention;

FIG. 1B shows a rear perspective view of the time-out device shown in FIG. 1A;

FIG. 1C illustrates a front perspective view of a preferred embodiment of a time-out device according to the present invention;

FIG. 2 is a schematic flow diagram depicting one specific example of a sequence of events during the operation of the time-out device shown in FIG. 1A, B & C; and

FIG. 3 shows a perspective view of a wireless remote control unit according to an embodiment of the present invention for operating the device shown in FIG. 1A, B & C.

### BEST MODE FOR CARRYING OUT THE INVENTION

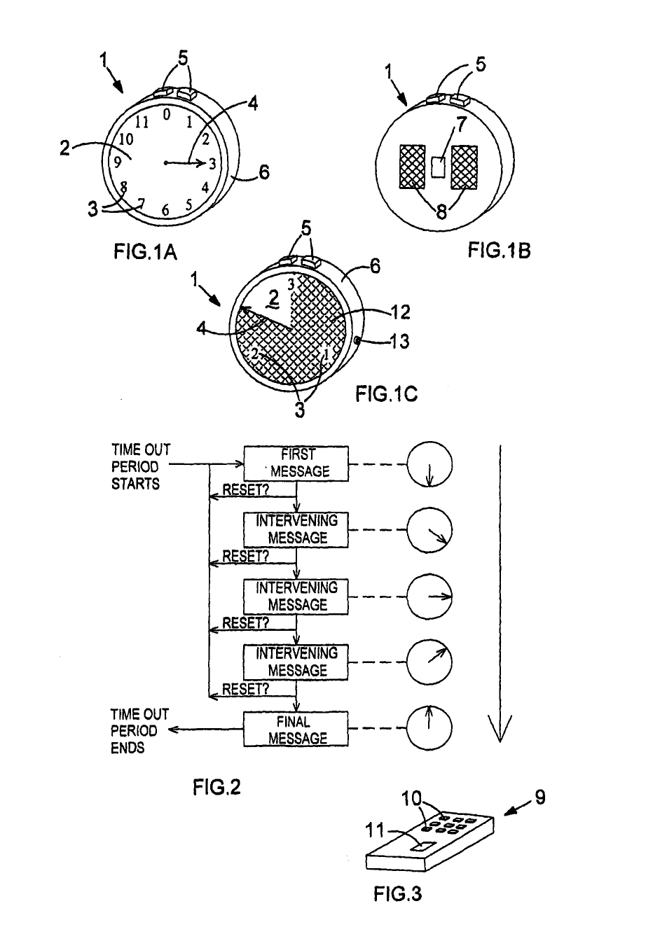

A time-out device 1 according to one embodiment of the present invention is shown in FIG. 1A having a timer display 2. In this example, the timer display 2 is a clock type face that has intervening linear periods of time indicated by numbers 3 to which a single sweep hand 4 points. Control buttons 5 allow the device to be started and, if necessary, re-set during the time out period. Such control buttons 10 may also or alternatively be provided upon a remote control device 9, the remote control device 9 being described in more detail below.

The rear of the device is shown in FIG. 1B which shows speakers 8 that emit pro-active audio messages to the child at set intervals as well as audio time reminders, and a control panel 7 that may enable the settings of the device's general functions to be varied.

Although a clock type face is preferred, older children may find a digital time output equally acceptable.

In use, a misbehaving child is placed in a suitably quiet location such as a ‘naughty step’ away from the parent or guardian and the device 1 is set for a period of time appropriate for their age. Thus, a period of 5 minutes may be set for a 5 year old and so forth. When the device 1 is started, an initial message is preferably emitted that tells the child that their period of time-out has started, how many minutes they have to stay in time-out and the need to use this time to reflect upon their preceding undesirable behavior. Thereafter, regular messages accompanied by time remaining, or served, reminders are typically emitted, usually coinciding with when the sweep hand 4 of the device reaches each number (3) on the clock-type face 2 (see FIG. 2). Finally, when the hand 4 reaches the top (or near it) of the face 2 (usually pointing to a ‘zero’) a final message is emitted at the conclusion of the time out period.

The auditory messages with accompanying minutes remaining, or served, reminders may come pre-recorded (preferably using an adult voice) or, alternatively, they can be re-recorded (preferably by the parent or guardian) by deploying such a facility located on the timer 1 and/or on a remote control device 9 (see FIG. 3).

Preferably, an auditory reminder of how many minutes are remaining, or served, in time-out is emitted to accompany the pre-recorded/re-recorded messages. This, coupled to the corresponding visual numeric display on the device, has the highly beneficial educational effect of familiarising young children with numbers and, specifically, the passing of time since it correlates in a linear, concrete way (as opposed to an arbitrary or abstract way) to actual time. Thus, 1 minute as depicted on the clock type face 2 is usually an actual minute of time-out, and so forth. This is more easily understood by children and helps in preparing them for learning about time and numbers. Moreover, it negates the need for children to inappropriately enquire and potentially engage the parent in interaction relating to the duration of their time-out period.

During time-out, if the child behaves in an undesirable fashion, thereby creating the need to re-set the time-out duration or add-on time, this can be done manually on the device control 5/7 itself, which is child tamper proof, and/or preferably on the wireless remote control unit 9 (see FIG. 3). The added benefit of the remote unit is that the parent can still control the time-out device 1 at a distance whilst avoiding unnecessary contact and interaction with the child. The remote unit 9 preferably has a simple indicator 11 corresponding to the device 1 time to remotely inform the parent of how long the child has remaining, or served, in time-out on the device 1. This allows the person enforcing the time-out period to go about their business during the time-out scenario and not to have to constantly keep a close watch on the child.

The device 1 can be placed near the child, either out of reach or within reach. The device may also include an attachment means to enable it to be fixed for example by being hung from a hook or such like. Alternatively, the device may be structured so as to be able to free standing and, as such, be capable of being placed on a step or shelf and so forth.

Preferably the device is robust and has a soft outer seal 6, such as rubber or plastic, which can protect it if dropped or mistreated and moreover ensure the safety of children throughout. The mechanisms of the device 1 and/or the remote unit 9 are also preferably child tamper-proof.

Optionally, a listening device may be attached to the device 1 that picks up and transmits surrounding sounds to the remote handset 9 that acts as the auditory receiving device to ensure that the child can be monitored (akin to a ‘baby monitor’) in terms of behavior and safety during time-out if, for instance, the time-out enforcer is going to be in a different room or area.

Similarly, this auditory listening option may be visual as well as auditory, if desired, for example by means of a small moving images camera attached to the device 1, the images from which may be transmitted to the remote handset receiver 9.

Optionally, a volume control function may be provided on the device 1, operated via the device control button(s) 5 or control panel 7 and/or the remote handset 9. The on/off button may be located on the device 1 itself and/or on the remote handset 9. The device 1 and the remote handset 9 may be electrically powered, for example from a battery, mains or solar-generated supply.

In a particularly preferred embodiment (see FIG. 1C), the device 1 has an LCD display 2 that preferably uses the whole of the display face 2 for any given time-out period setting. The displayed period may be activated via the remote control 9 (FIG. 3), the start preferably being indicated at the top of the clock type face 2 for example with a single hand 4 sweeping counter-clockwise from the top, returning back around to the top finish point, and encountering intervening minute markers 3 along the way. Additionally, the duration of the time remaining may be represented as one or more highlighted coloured zone(s) 12 of contrasting colour, the size or number of the zone(s) diminishing either continuously or in discrete segments as less time remains and until time-out eventually finishes. In a preferred embodiment, one zone is used that ever diminishes in a continuous manner, being preferably coloured red.

An optional earphone socket 13 may be provided, enabling headphones/earphones to be used to listen to the auditory messages in noisy or busy environments such as classrooms.

The time-out duration is usually set according to the age of the child, according to an accepted 1 minute per age of child rule of thumb, so that a 3 year old should be set 3 minutes on the device, a 5 year old 5 minutes, and so on. Furthermore, time may be added-on for deviations during time-out, for example in increments, with 1 minute increments being the optimum in most particularly preferred embodiments.

In summary, the present invention solves the problem of guiding a child to think about their behavior during a time-out period via recorded voice reminders; avoiding interaction with the child during the period (since the device shows and gives feedback as to how long they have remaining, or served); and has the added educational advantage of helping children to understand the passing of time, as well as familiarising them with numbers in general.

1.-21. (canceled)

22. A time-out device for aiding behavioural reflection by a misbehaving child, comprising:
(I) a timer unit, the timer unit providing a visual indication of passage of time in a time-out period, the indication being one of (a) remaining time of the timeout period to be served and (b) already-served time of the time-out period;
(ii) an audio unit comprising memory means for storing a plurality of pre-recorded voice messages, and playing means operable to audibly relay the pre-recorded voice messages to the child; and
(iii) operating means to operate the playing means in dependence upon the passage of time in the time-out period, the operating means operating the playing means synchronized to the passage of time in the time-out period to relay the pre-recorded voice messages to the child in time-related succession through the time-out period.

23. The time-out device according to claim 22, wherein the pre-recorded voice messages comprise information to reinforce behavioural reflection by the child during the time-out period; and reminders of one of (a) time of the time-out period remaining to be served, and (b) time of the time-out period served.

24. The time-out device according to claim 22, wherein the pre-recorded voice messages are sequentially and linearly time-related.

25. The time-out device according to claim 22, wherein the timer unit provides the visual indication of passage of time in analog form.

26. The time-out device according to claim 25, wherein the timer unit includes a sweep hand to provide the analog indication of time.

27. The time-out device according to claim 25, wherein the timer unit includes means to provide the analog indication of time as a visually-distinctive zone that reduces in size with passage of time through the time-out period.

28. The time-out device according to claim 22, wherein the timer unit provides the visual indication of passage of time in digital form.

29. The time-out device according to claim 22, including re-set means, and the re-set means being operable during the time-out period to extend the time-out-period.

30. The time-out device according to claim 22, in combination with a remote handset for controlling functions of the time-out device.

31. The combination of time-out device according to claim 22, in combination with a remote handset for controlling functions of the time-out device, wherein the remote handset includes re-set means, and the re-set means being operable during the time-out period to extend the time-out period.

32. A method for aiding behavioural reflection by a misbehaving child during a period of time-out, comprising:
(I) operating a timer unit to provide a visual indication to the child of passage of time in a time-out period, the indication being of one of (a) remaining time to be served of the period of time-out, and (b) already-served time of the period of time-out;
(ii) storing a plurality of pre-recorded voice messages; and
(iii) audibly relaying the stored pre-recorded voice messages to the child synchronised to the passage of time in the time-out period, the audibly relaying of the pre-recorded voice messages to the child being in time-related succession through the time-out period.

33. The method according to claim 32, wherein the pre-recorded voice messages comprise information to reinforce behavioural reflection by the child during the time-out period; and reminders of one of (a) time of the time-out period remaining to be served, and (b) time of the time-out period served.

34. The method according to claim 32, wherein the pre-recorded voice messages are sequentially and linearly time-related.

35. The method according to claim 32, wherein the pre-recorded voice messages comprise a first pre-recorded voice message relayed to the child initially in the time-out period indicating commencement of the time-out period together with need for reflection during the time-out period; at least one pre-recorded voice message relayed to the child within the time-out period to focus attention on reflection on misbehaviour by the child; and a final pre-recorded voice message relayed to the child finally in the time-out period indicating end of the time-out period.

36. The method according to claim 35, wherein the final pre-recorded voice message indicates the need to apologize to and hug the person enforcing the time-out period.

37. The method according to claim 32, wherein the pre-recorded voice messages are each accompanied by a pre-recorded auditory reminder of the number of units of time remaining to be served in the time-out period.

38. The method according to claim 32 wherein the pre-recorded voice messages are each accompanied by a pre-recorded auditory reminder of the number of units of already-served time of the time-out period.
